(19) United States
(12) Patent Application Publication
(10) Pub. No.: US 2002/0064053 A1
(43) Pub. Date: May 30, 2002

(54) Vehicle lamp

(75) Inventors: Hidetaka Anma, Shizuoka (JP); Takaya Nakamura, Shizuoka (JP); Mariko Tanaka, Shizuoka (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: KOITO MANUFACTURING CO., LTD.

(21) Appl. No.: 09/977,996

(22) Filed: Oct. 17, 2001

(30) Foreign Application Priority Data
Oct. 17, 2000 (JP) P2000-316417

(51) Int. Cl. F21V 7/00

(52) U.S. Cl. 362/517; 362/520; 362/304; 362/310

(57) ABSTRACT

A vehicle lamp having a front lens that contains an antistatic agent in a base material forming the front lens. In one embodiment, the lamp includes, in addition to the front lens, a light source, a lamp body for containing the light source and forming a lamp chamber, and a reflective mirror which is disposed in the lamp chamber and used for forming outside irradiation light by reflecting light emitted from light source. The reflective mirror may include a main reflective surface portion for reflecting the light emitted from the light source, and the lamp may also include an extension reflector formed integrally with or separately from the main reflective surface portion of the reflective mirror. The front-end portion of the extension reflector portion may be disposed opposite to the front lens containing the antistatic agent.

### BACKGROUND OF THE INVENTION

1. Field of the Invention

The present invention relates to a vehicle lamp such as an automotive headlamp.

More particularly, the present invention relates to a vehicle lamp in which antistatic measures have been taken for the material of the front lens made of, for example, transparent polycarbonate or any other synthetic resin or material employed in vehicle lamps.

2. Description of the Related Art

With the progress in recent years of luminous distribution control technology by means of reflective mirrors (reflectors) in vehicle lamps, especially automotive headlamps, there have increasingly been adopted transparent front lenses with no steps engraved therein.

The prevailing tendency is for such a transparent front lens to be formed of a synthetic resin, for example, polycarbonate resin especially in view of the resin's shock resistance, dimensional stability during molding, lightness, transparency, and so on.

Moreover, the provision of a reflective mirror in the lamp chamber of a vehicle lamp results in disposing a gap covering member generally called an extension reflector in the vicinity of the inner wall surface of the front lens in order that the gap formed between the reflective mirror and a lamp body may be made hardly visible from the outside.

However, the conventional vehicle lamps described above exhibit the following technical problems.

Synthetic resin, especially polycarbonate resin, is conventionally used as a material for the front lens. Synthetic resin is a highly transparent material that is processed at high molding temperatures. This transparent material is hardly able to demonstrate its antistatic function and is easily subjected to electrical trouble because of the material's high electrical non-conductance.

This electrical trouble, that is, when the front lens is electrically charged and natural discharging occurs may be exhibited, for example, when: (1) the molded front lens is removed from a mold during manufacturing; (2) the front lens is hit by electrically charged dust and sand during traveling and so forth; or (3) the front lens is dry-wiped such as after car washing. In particular, in an automobile front lens, the discharging may concentrate on the aluminum-deposited extension reflector disposed in the vicinity of the front lens.

When dust and dirt present in the lamp stick to the front lens, a tree pattern including those called tree or static marks is formed on the inner surface of the front lens which results in creating a poor external appearance of the lens.

For example, as shown in FIG. 5, tree marks 22 appear in a manner concentrating in the portion of a front lens 21 adjacent to an extension reflector 23 placed so as to surround a lamp chamber in the vicinity of the inside of the front lens 21 as externally viewed, creating a diminished external appearance.

### SUMMARY OF THE INVENTION

An object of the present invention is to provide a vehicle lamp that prevents the generation of tree patterns or marks by adding an antistatic function to a front lens material of the vehicle lamp.

In order to accomplish the object above, the following means are adopted.

A vehicle lamp according to the present invention includes a front lens that contains an antistatic agent in a base material forming the front lens. In an embodiment of the present invention, the vehicle lamp may also include a light source, a lamp body for containing the light source, a resin-made front lens for closing the front opening portion of the lamp body, and a reflective mirror disposed in a lamp chamber formed with the front lens and the lamp body. The lamp may also include a feature whereby the reflective mirror includes a main reflective surface portion for reflecting light emitted from the light source, and an extension reflector portion formed integrally with or separately from the main reflective surface portion and wherein the front-end portion of the extension reflector portion is disposed opposite to the front lens.

Since the front lens of the present invention itself has an antistatic function through the means described above, the antistatic effect is demonstrated to the front lens, irrespective of the method of manufacturing the front lens, the condition of use, the construction of the lamp, and so forth, which effectively prevents the generation of tree marks in the lens.

More specifically, in the case where electrically charged particles and grains of dust and sand are brought into contact with the front lens during manufacturing, traveling, dry-wiping after car washing, and so forth, the present invention effectively prevents not only natural discharging, but also discharging between the front lens and the extension reflector disposed, for example, in the vicinity of and opposite to the front lens.

As an antistatic agent to be contained in a base material of the front lens, a surface-active agent may be employed. More particularly, one of the ion surface-active agents including alkylbenzene sulfonate, tetraalkyl-ammonium salt, alkylbetaine and any other ion surface-active agent or otherwise one of the non-ion surface-active agents including glycerin fatty ester, polyoxyethelene alkyl ester and any other non-ion surface-active agent may be used.

During manufacture of the front lens, a predetermined amount of synthetic resin such as polycarbonate resin or the like as the base material is kneaded with the surface-active agent and the mixture is bled out at the time of molding. Accordingly, a thin water layer is allowed to form on the inner wall surface of the front lens since the hydrophilic group of a surface-active agent existing in the surface layer of the base material attracts vapor in the air. Thus, conductance is given by the water layer to the inner wall surface of the front lens (or, in other words, the surface resistance value Ω/cm² is lowered), so that discharging hardly occurs. Therefore, tree marks are not formed on the front lens.

In a conventional synthetic resin, and especially a polycarbonate resin used in a front lens, the initial surface resistance value may be approximately 1×10¹⁶ Ω/cm². Should an antistatic treatment be applied to the front lens from the material surface, the initial surface resistance value of the front lens may be set at 1×10¹³ Ω/cm² or less to prevent discharging of the front lens.

The initial surface resistance value is defined as the electric resistance value between both poles when voltage is applied with a pair of opposed sides as electrodes on the assumption of a square having sides of 1 cm, and a resistance value being shown by Ω.

The invention is especially fit for a vehicle lamp in which the extension reflector is disposed in the vicinity of the front lens where tree marks are easily generated, whereby the discharging of the front lens as well as the extension reflector is preventable.

In comparison with a method of providing an antistatic treatment by applying coating (e.g., non-fogging coating) to the surface of the front lens, it is unnecessary to add the step of coating the surface of the front lens during manufacturing of front lenses according to the invention. Therefore, the invention is advantageous in view of the manufacturing process and cost of the front lens.

Although electrical charging is not preventable at the drawing step of molding in the conventional antistatic method using coating, it is ensured according to the invention that the electrical charging at the drawing step of molding is prevented since the antistatic treatment is applied to the material itself of the front lens.

As set forth above, tree marks causing a poor external appearance are prevented from being generated on the front lens by adding the antistatic function to the material itself of the front lens and therefore, the quality of vehicle lamps is improved.

### BRIEF DESCRIPTION OF THE DRAWINGS

FIG. 1 is a vertical sectional view of one embodiment of the present invention, showing the overall construction of a vehicle lamp (1) wherein an extension reflector is formed separately from the main reflective mirror portion.

FIG. 2 is a vertical sectional view of another embodiment of the present invention, showing the overall construction of a vehicle lamp (1′) wherein an extension reflector is formed integrally with the main reflective mirror portion.

FIG. 3 is an enlarged sectional view of an encircled portion in FIG. 1 shown by a symbol X.

FIG. 4 is a diagram showing how a water film is formed on the surface of a base material prepared by adding is a surface-active agent to polycarbonate resin.

FIG. 5 is a diagram showing a state of a front lens having a poor external appearance due to the generation of tree marks.

### DETAILED DESCRIPTION OF THE INVENTION

Embodiments of the present invention will now be described by reference to the accompanying drawings.

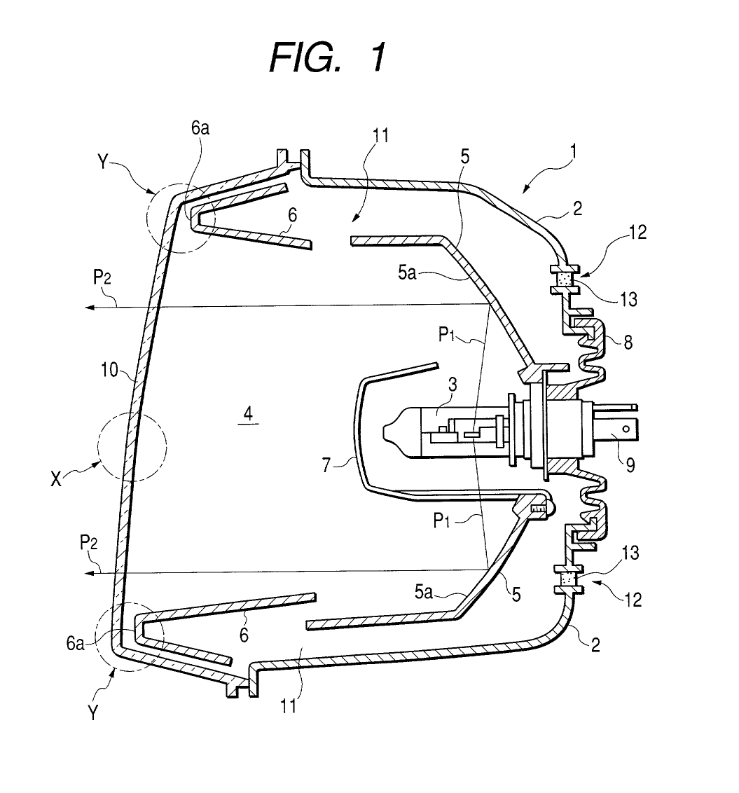

The overall construction of a vehicle lamp according to an embodiment of the invention is shown in FIG. 1. The vehicle lamp 1 comprises a light source 3, a lamp body 2 for forming a lamp chamber while containing the light source 3, a reflective mirror (reflector) 5 for forming outside irradiation light P₂ by reflecting light P₁ emitted from the light source 3, a transparent polycarbonate front lens 10 for transmitting the outside irradiation light P₂ by closing the front opening portion of the lamp body 2, and extension reflectors 6 placed in the vicinity of the front lens 10 in order to cover a gap 11 formed between the reflective mirror 5 and the lamp body 2. On the extension reflector 6, a metal film is provided with aluminum deposition and the like.

The extension reflector 6 of the vehicle lamp 1 is formed separately from the main reflective mirror surface portion 5a of the reflective mirror 5. In this case, the main reflective mirror surface portion 5a means a reflective mirror surface portion for use in demonstrating the function of forming the outside irradiation light P₂ by reflecting the light P₁ emitted from the light source 3.

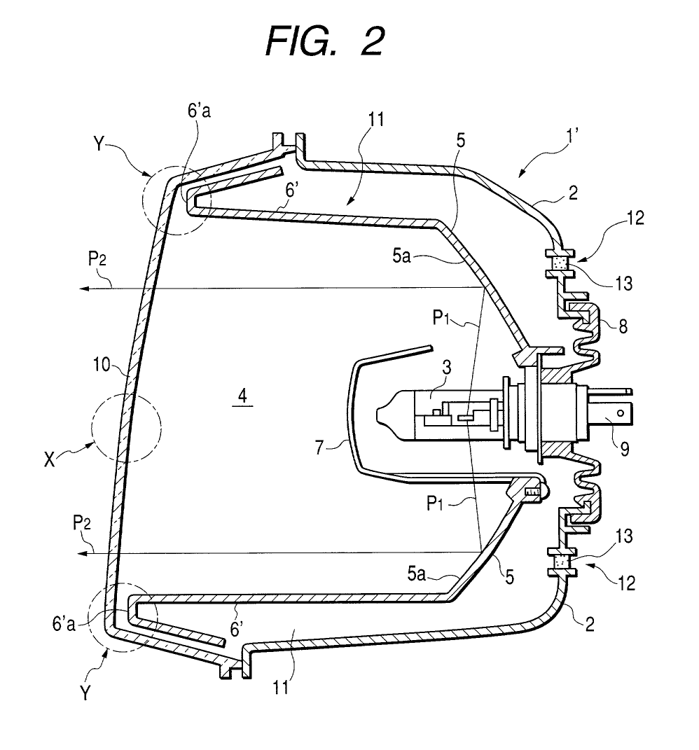

In another embodiment of the present invention as shown in FIG. 2, the extension reflector 6′ of vehicle lamp 1′ is formed integrally with the main reflective mirror portion 5a of a reflective mirror 5. The remaining construction of the lamp in the embodiment shown in FIG. 2 is similar to that of vehicle lamp 1. of course, the various components and configuration of the lamp in conjunction with the lens of the present invention may be altered without deviating from the scope of the present invention. For example, although the light source 3 in FIGS. 1 and 2 is depicted as an H4 bulb, a discharge bulb, for example, may be used instead of the H4 bulb.

Reference numeral 7 in FIGS. 1 and 2 denotes a shade for making the light source 3 invisible from the outside; 8, a back cover for closing a rear opening portion 14 for use in mounting the light source of the lamp body 2; 9, a power feed terminal; 12 and 12, breathing holes provided in the rear top portion of the lamp body 2; and 13 and 13, mesh filters fitted into the respective breathing holes 12 and 12.

In the vehicle lamps 1 and 1′ thus constructed, the front end portions 6a and 6a′ of the respective extension reflectors 6 and 6′ are arranged so that they are disposed opposite to each other and close to the side wall surface of the lamp chamber 4 of the front lens 10 made of synthetic resin, such as polycarbonate. Consequently, electricity is set readily dischargeable between the extension reflectors 6 and 6′ of the front lens 10.

Therefore, the present invention allows for effectively preventing electrical discharging from occurring without changing the arrangement of the extension reflectors 6 and 6′ in the vehicle lamps 1 and 1′ in which the discharging tends to readily occur between the front lens 10 and the extension reflectors 6 and 6′.

The present invention prevents discharge by including materials in the front lens 10 that have proven by experimentation to have a high antistatic effect. Accordingly, the base material of the front lens, such as polycarbonate resin, includes a surface-active agent. Surface-active agents used in the present invention may include, for example, one of the ion surface-active agents including alkylbenzene sulfonate, tetraalkyl-ammonium salt, alkylbetaine or any other ion surface-active agent or otherwise one of the non-ion surface-active agents including glycerin fatty ester, polyoxyethelene alkyl ester or any other non-ion surface-active agent.

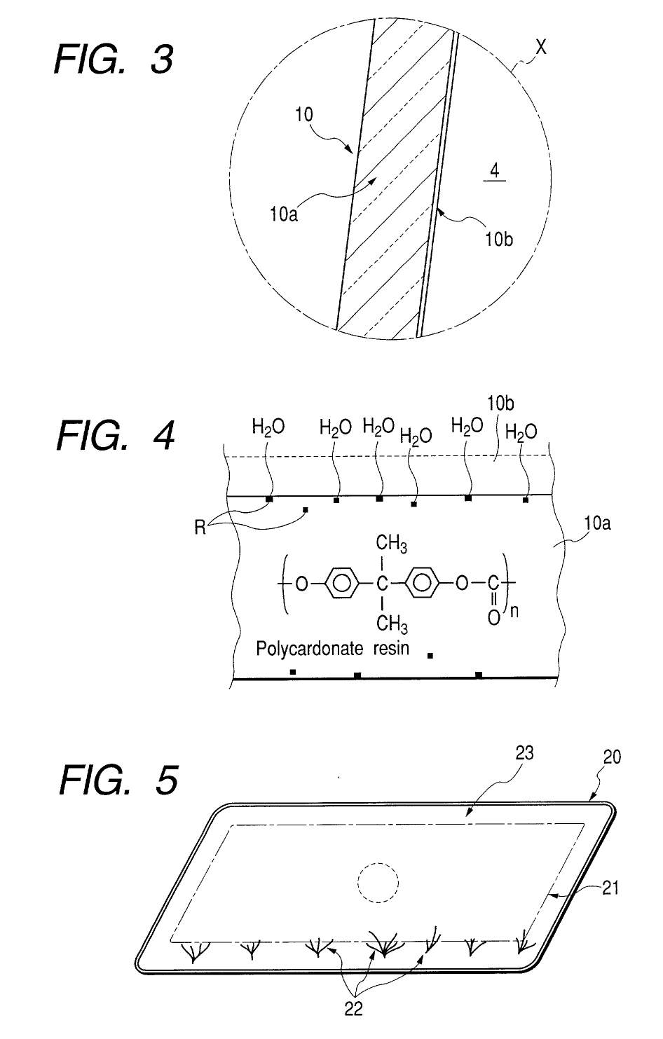

The front lens 10 may be formed by kneading a predetermined amount of synthetic resin such as polycarbonate resin or the like as the base material with the surface-active agent and bleeding out the mixture at the time of molding. Thus, the hydrophilic group of a surface-active agent existing in the surface layer of the base material attracts vapor in the air, so that a thin water layer 10b can be formed on the inner wall surface of the base material 10a of the front lens 10 (see FIGS. 3 and 4).

The inner wall surface of the front lens 10 is supplied with conductivity by the water layer 10b, and therefore, the surface resistance value (Ω/cm², or sometimes symbolized by Ω/□) is lowered so as to prevent discharging from occurring. As such, no tree marks are generated on the front lens 10.

Particularly in the portions (circular portions indicated by a symbol Y in FIGS. 1 and 2) of the front lens 10 facing the extension reflector 6 disposed in a position close to the front lens 10 in the lamp chamber 4, tree marks are readily generated by the discharging of the extension reflector 6 of the front lens 10. However, the tree marks are not easily generated by employing the front lens 10 containing the surface-active agent.

Therefore, the extension reflector 6 can be installed in the vehicle lamp 1 without worry because it is possible to solve the conventional problem of fostering the generation of tree marks by providing the extension reflector.

Further, as no discharging occurs even though the extension reflector 6 is disposed close to and opposite from the front lens 10, freedom of designing the interior of the lamp chamber 4 is enhanced.

The present inventors performed the following tests to determine the values at which the surface resistance of the front lens 10 was set when an antistatic treatment was provided by causing the front lens 10 to contain the surface-active agent.

Lens samples of polycarbonate resin having initial surface resistance values of 1×10¹⁵ Ω/cm², 1×10¹⁴ Ω/cm², 1×10¹³ Ω/cm², 1×10¹² Ω/cm² in terms of actually measured values were chosen and used as front lenses 10.

Sand containing boxes for use in European Resin-Made Lens Tests for Resistance of Scuffing were attached onto bumpers of automobiles, which were made to travel on expressways at a speed of 100 km per hour. Then the lens samples were taken out of the headlamps and tree marks were confirmed by use of toner. The headlamps used were constructed such that the extension reflector 6 was disposed close to the front lens 10.

Table 1 shows the test results.

TABLE 1

| | | | | |
|---|---|---|---|---|
| Surface | 1 × 10¹⁵ | 1 × 10¹⁴ | 1 × 10¹³ | 1 × 10¹² |
| resistance | | | | |
| value of | | | | |
| lens sample: | | | | |
| (Ω/cm²) | | | | |
| Presence or | present | present | absent | absent |
| absence of | | | | |
| tree marks: | | | | |

As shown in Table 1, in the case where the initial surface resistance value of the front lens 10 is 1×10¹³ Ω/cm² or less, no tree marks are obviously generated, even on the condition that the extension reflector 6 is disposed close to the inside of the front lens 10 (where tree marks are typically easily generated).

Therefore, it is preferred to set the initial surface resistance value of the front lens 10 at 1×10¹³ Ω/cm² or less.

Also, it was determined that the degree of content of a surface-active agent to be contained in the polycarbonate resin so as to set the initial surface resistance value at 1×10¹³ Ω/cm² or less, is approximately 2 wt %.

In other words, the present inventors have shown that tree marks may be prevented from being generated on the front lens 10 by causing the polycarbonate resin to contain 2 wt % of the surface-active agent.

With the vehicle lamp according to the present invention, poor external appearance of the lamp, and particularly the lens may be eliminated because tree marks are prevented from being generated on the front lens.

Also, in the present invention, the extension reflector may be disposed a predetermined space apart (5 mm or less) from the front lens in the lamp chamber without incurring tree marks on the lens, despite the arrangement of the extension reflector as described above even in the vehicle lamp in which the front lens tends to be electrically charged by the discharging of the front lens and the extension reflector.

The vehicle lamp of the present invention, in which the antistatic function is added to the base material itself of the front lens, allows for an improved manufacturing process than that employed for coating a front lens with an antistatic coating to ensure that the molded base material is prevented from being electrically charged when it is removed from the die. Moreover, the invention contributes to reducing costs as not only the antistatic coating costs but also the material costs are reducible.

What is claimed is:

1. A vehicle lamp comprising a front lens, the front lens containing a base material having an antistatic agent disposed within the base material.

2. The vehicle lamp according to claim 1, wherein the antistatic agent is a surface-active agent.

3. The vehicle lamp according to claim 1, wherein an initial surface resistance value of the front lens is 1×10¹³ Ωcm² or less.

4. The vehicle lamp according to claim 2, wherein an initial surface resistance value of the front lens is 1×10¹³ Ω/cm² or less.

5. The vehicle lamp according to claim 1, further including a main reflective surface and an extension reflector operable to reflect light from a light source, wherein a front end portion of the extension reflector is disposed opposite to the front lens and a metal film is provided on the extension reflector.

6. The vehicle lamp according to claim 5, wherein the extension reflector is formed integrally with the main reflective surface.

7. The vehicle lamp according to claim 5, wherein the extension reflector is formed separately from the main reflective surface.

8. The vehicle lamp according to claim 1, further including a light source, and a lamp body having a front opening portion covered by the front lens.

9. The vehicle lamp according to claim 1, wherein the antistatic agent disposed within the base material is approximately 2 wt %.
